(19) United States
(12) Patent Application Publication
(10) Pub. No.: US 2024/0394891 A1
(43) Pub. Date: Nov. 28, 2024

(54) CONTEXT BASED ADAPTABLE VIDEO CROPPING

(71) Applicant: Brahmadev Sharma, Gwalior (IN)

(72) Inventor: Brahmadev Sharma, Gwalior (IN)

(21) Appl. No.: 18/689,096

(22) PCT Filed: Sep. 5, 2022
(86) PCT No.: PCT/IB2022/058324

§ 371 Date: Mar. 5, 2024

(30) Foreign Application Priority Data
Sep. 5, 2021 (IN) 202121040212

(51) Int. Cl. G06T 7/12; G06T 7/13; G06T 7/20; G06T 7/70; G06V 40/16; G06V 40/20

(52) U.S. Cl. CPC G06T 7/12; G06T 7/13; G06T 7/20; G06T 7/70; G06V 40/161; G06V 40/23; G06T 2207/20132; G06V 2201/07

(57) ABSTRACT

The invention provides dynamic cropping of videos for playback on a display unit having different aspect ratio than the aspect ratio of the video. The invention allows smart or intelligent cropping of video by identifying context of the video. The video is cropped surrounding an object present in the video which correlates with the identified context of the video.

### FIELD OF INVENTION

The present invention relates to image or video processing. More specifically the present invention relates to context based dynamic cropping of video for playback over a display region having a different aspect ratio than the aspect ratio of the video. Alternatively, the invention relates to streaming a dynamically cropped video to be displayed on a small display having a different aspect ratio from an aspect ratio of the video.

### BACKGROUND & PRIOR ART

The following description includes information that may be useful in understanding the present invention. It is not an admission that any of the information provided herein is prior art or relevant to the presently claimed invention, or that any publication specifically or implicitly referenced is prior art.

At present, technique known as letterboxing (unused border around the video image to fill the entire display as disclosed in U.S. Pat. No. 5,825,427) is applied while playing a video on a display having different aspect ratio than the aspect ratio of video. However, letterboxing technique leaves a significant display area unused. Other method of displaying video on a display having different aspect ratio than the video includes stretching or compressing the video either horizontally or vertically to fill the entire display area. Alternatively, a fixed crop window is applied over video where the fixed crop window corresponds to the aspect ratio of the display.

Some of the cropping methods in prior arts US20120086723A1, U.S. Pat. No. 8,416,277B2 and US20220108419A1, discloses dynamic adjustment of crop area or crop window based on either for different display properties, region/object of interest in the image (video frame) etc. However, the contents of video are much more complicated than these image based cropping methods and may not suitable for many situations.

### SUMMARY

The present invention determines a dynamic crop region (crop window) in a video. The dynamic crop region enables cropping video segments to keep one or more main subject(s) of the video into the dynamically cropped region. The main subject(s) in a frame of the video is determined based on the context of the video or context of a video segment having the frame. The crop region is also determined based on one or more of factors including: (a) aspect ratio of the display (b) resolution of the display (b) physical dimensions of the display.

The dynamic cropping of the video according to the present invention allows comfortable viewing of the cropped video over a small display.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

The diagrams are for illustration only, which thus is not a limitation of the present disclosure, and wherein:

FIG. 1a to FIG. 5 illustrates different scenarios of dynamic determination of crop region.

FIG. 6a and FIG. 6b illustrates a system for dynamically determining of the crop region.

FIG. 7 illustrates a block diagram of a method for dynamically determining the crop region.

### DETAIL DESCRIPTION OF DRAWINGS

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure.

In the following description, numerous specific details are set forth in order to provide a thorough understanding of embodiments of the present invention. It will be apparent to one skilled in the art that embodiments of the present invention may be practiced without some of these specific details.

The present invention discloses a method and a system for dynamically cropping a video, to effectively display a main subject/object of the video on a display unit (or a display region for displaying video) having either a different aspect ratio then the video, a different shape (i.e. oval, circular), a different resolution or a small display size (such as smart watch display unit). However, the invention is not restricted to the smart watch display unit and can be applied to display of vehicle infotainment system, a display of smartphone, a secondary display of smartphone (i.e. secondary display of foldable smartphones), different orientation of display units (i.e. landscape and portrait orientation of smartphones), head-up display etc. Further, the invention can also be applied for playback of video in a Picture-in-Picture (PiP) floating window, such as YouTube miniplayer. Further, the present invention enables displaying the cropped video on a small portion of the total display area. Further, the present invention is applicable as an accessibility technique for visual impaired user. Furthermore, the invention can be applied for dynamic cropping of panoramic, spherical or 360 degree video for displaying on a conventional display such as television, smartphone, computer monitor etc.

The invention allows smart or intelligent cropping of video by correlating context of the video with the objects present in the video segments. Alternatively, the context of the frame or context of the video segment can be used for intelligent cropping.

According to an embodiment of the present invention, at least a part of video (video segment) is processed to identify one or more boundaries of at least one object of interest in at least one video frame of the video segment, and identifying a dynamic crop region surrounding the boundaries of the at least one object of interest in the at least one video frame. The dynamic crop region is determined in a way to contain the object of interest according to the aspect ratio of display unit or display area, while cropping out the other parts of video frame. In a compressed video the boundary of the at least one object of interest is identified in a key frame of the compressed video and cropped region is dynamically adjusted based on the motion vectors associated with the at least one object of interest to dynamically adjust the position of cropped region in the subsequent inter frames.

The size of dynamic crop region is partially determined based on the dimensions (i.e. vertical and horizontal pixel counts) of the identified at least one object of interest. Further, the dynamic crop region also includes some surrounding area around the identified at least on object of interest. The amount of included surrounding area is partially determined based on the at least one of the (a) dimensions of the identified at least one object of interest, (b) change of position of the object of interest in subsequent frames (P and/or B frames), (c) physical dimensions of the target display.

The processing of the frames can be performed in near real-time or the complete video can be processed once and metadata for dynamic crop can be created and stored with the video. The processing can be performed at the display device (i.e. smartphone). The processing can be performed on a main device and dynamically cropped video can be streamed to a paired companion device (i.e. smart watch, smart glasses or any other wearable device). Alternatively, the processing can be performed at a server or at a cloud and a pre-cropped video is streamed to the target display device. Alternatively, the cloud or server streams the original video along with metadata defining parameters for applying dynamic crop by the target display device. The processing to find the at least one object of interest includes but not limited to face detection, human body detection, animal detection, object detection etc.

According to an embodiment of the present invention, an artificial intelligence (AI) engine is used to identify the context of video or video segment and one or more object of interest in video segments or in frames of video. A context of frame can also be determined for individual frames for more granular approach. For sack of conserving processing power, context of video or context of video segment can be considered as context of the video frame. Alternatively, a user or a system administrator can provide context of the video. The object of interest includes human subjects (i.e. a news anchor, weatherman, a lead dancer, a lead singer), animal subjects (i.e. dog, cat, wild animals etc.), other subjects (i.e. car, toy) etc. Further, the object of interest can be a part of the human subjects, animal subjects, or other subjects, for example face of human or animals or other body part (based on the context of the video segment). Further, the object of interest can be interaction/action involving the human subjects, the animal subjects, or the other subjects. In complex scenes, such as multiple humans (actors, anchors) are simultaneously present in frames of a segment of the video, the AI engine process the video segment or at least a part of timeline of the video segment to identify relevant object of interest in frames of the video segment. The AI engine can identify the object of interest based on one or more of a face detection, emotion detection, human body detection, animal detection, lip movement detection (indicating one of the multiple human is speaking), face and body movement detection. The AI engine further identify the context of the video segment using data such as audio processing for voice or audio direction detection (i.e. left, right, center audio channel), natural language processing for vocals or subtitles, title of the video, hashtag of the video. The AI engine also identifies background and foreground objects in the video segment to determine context of the video segment. Based on the context of the video segment the AI engine determines associated objects (i.e. object of interest) in one or more video frames of the video segment.

Use of the video context enables correct identification of object of interest in corresponding video segments or in video frames. For example, in a video where more than one human subject is present, based on direction of vocals present in the corresponding audio track of the video segment, the AI engine determines human (or face of human) which is speaking as the object of interest (i.e. a left channel having presence of more weightage of vocals than the right channel, indicates a human subject present on left side in the video frame is the object of interest). In a different example, in a video related to hair styling where a hairdresser and a model is present and hairdresser is verbally narrating process of hair styling and simultaneously performing hair styling of the model. Although, the hairdresser is speaking and the model is not speaking or performing any task, by using natural language processing of either of voice, subtitles, video title and description of video, the context of video is identified which is related to action being performed on hairs. Based on the identified context, object of interest is identified as the hair of the model and a dynamic crop region is determined keeping the hair of the model in crop region with some portion of surrounding of the hair. In an alternate example for a cooking show, the object of interest can be a frying pan where ingredients are being mixed and not the chef narrating the process of making a dish. Alternatively, a user or system administrator can provide or refine the context of the video.

According to another embodiment of the present invention, a video cropping platform (or a video cropping service) scan or crawl one or more video databases (offline and/or online) to identify one or more videos which can be effectively cropped for displaying on a small display device (i.e. wearable device). The at least one database includes videos stored at a local device (i.e. PC, laptop, smartphone, network attached storage etc.), videos on a server or cloud, videos from a video streaming platform (i.e. YouTube, Netflix, Disney plus etc.).

The video cropping platform stores addresses of the identified one or more videos. The address includes a file location of a video stored in a local database or a URL of a video available on online database. The indexing database further stores thumbnails, titles, and other information corresponding to the identified one or more videos. The video cropping platform can process the videos and store information regarding object of interests in video segments or in frames of the video preferably in form of dynamic crop metadata.

The video cropping platform provides a user interface or a graphical user interface (GUI) to end user via a software application or a web application. The user interface can be adapted for small screen display device and enables user of the small screen device to navigate through the list of the identified one or more videos and allows selecting a desired video to be played on the small screen device which is cropped according to one of the embodiments of this invention.

Exemplary embodiments will now be described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the art. The invention disclosed may, however, be embodied in many different forms and should not be construed as limited to the embodiments set forth herein.

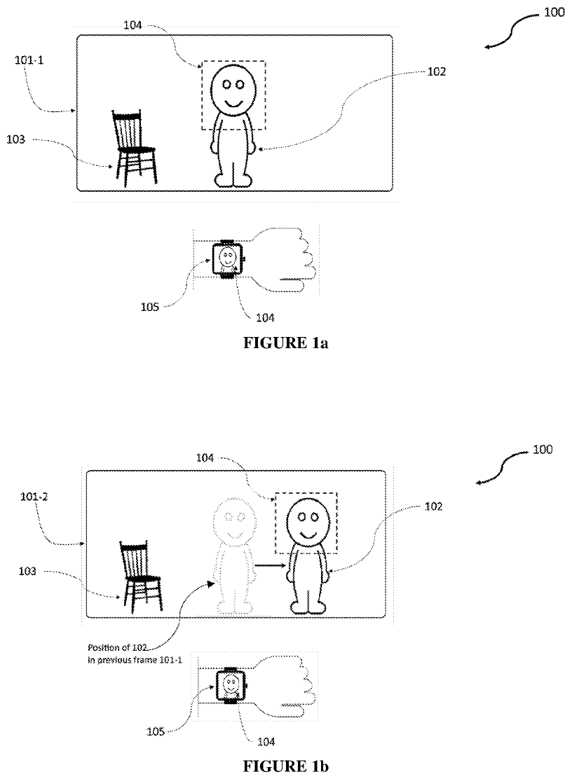

FIG. 1a illustrates dynamic determination of cropped region in a first scenario 100. The FIG. 1 describes a frame (I Frame) 101-1 of a video containing a human subject 102 and an other object (i.e. chair) 103. The object of interest here is face of the human subject. A crop region 104 around the face of the human subject is applied on the frame 101-1. The crop region 104 contains face of the human subject and a portion of an area surrounding the face of the human subject. The video frame 101-1 is cropped according to the determined crop region and is displayed on a screen of a wearable device 105. The cropped region 104 allows a viewer to see the face clearly on the screen of the wearable device 105, which is relatively smaller in comparison of a display of conventional video consumption devices (i.e. smartphone, tablet, television etc.). Further, the surrounding area included in the cropped region, enhances visual comfort as well as allows a buffer area to allow some degree of face movement (shift of position) in subsequent frames without requiring an adjustment of the cropped region. If the location of the face of human subject shifts in subsequent frames causing at least some part of the face is not contained within the cropped region, the crop region is adjusted in subsequent frames accordingly.

FIG. 1b describes a next frame (inter frame) 101-2 which is subsequent to the frame 101-1. In the next frame 101-2 the position of the human subject 102 has been shifted from the position of human subject in the frame 101-1. As a result, the position of the object of interest (face of the human subject 102) is also shifted in the next frame 101-2. To keep the object of interest visible, the position of the crop region 104 is shifted (dynamically adjusted) in the next frame 101-2 to keep the object of interest in the cropped region. In case of a zoom-in or zoom-out occurred in the next frame, the size of crop region is also dynamically adjusted to keep the object of interest in the cropped region (not shown).

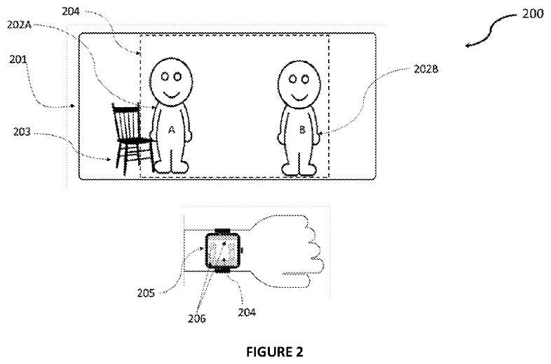

FIG. 2 illustrates dynamic determination of cropped region in a second scenario 200. FIG. 2 shows a frame 201 containing a first human subject 202A and a second human subject 202B positioned at a distance from each other. Here, first and second human subjects or faces of the first and second human subjects represent object(s) of interest. The frame 201 may also contain another object 203. The cropped region 204 is applied keeping the first human subject 202A and the second human subject 202B inside of the cropped region. The cropped region of the frame 201 is displayed on to a screen of a wearable device 205. If keeping first and second human subject in the cropped region 204 makes the aspect ratio of cropped region 204 comparatively wider than the aspect ratio of the wearable device 205 (still less wide than the aspect ratio of the video frame 201), letterboxing can be applied. As shown black bars 206 are placed at the top and bottom of the cropped region 204 (letterboxing) to display on to the screen of the wearable device 205.

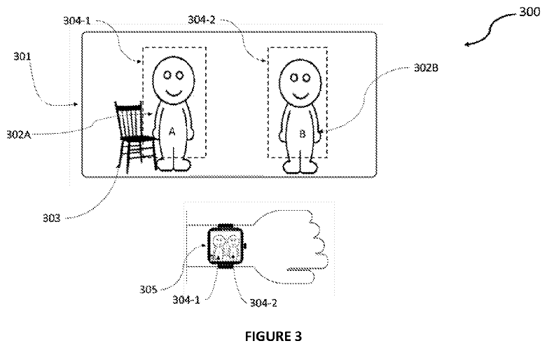

FIG. 3 shows another scenario 300 of selecting a cropped region when more than one object of interest present in a frame 301. The frame 301 containing a first human subject 302A and a second human subject 302B positioned at a distance from each other. Here, first and second human subjects or faces of the first and second human subjects represent area of interest. The frame 301 may also contain another object 303. A first crop region 304-1 is determined corresponding the first human subject 302A and a second crop region 304-2 is determined corresponding to the second human subject 302B. The first and second cropped regions each have a combined aspect ratio equal or nearly equal to the aspect ratio of display of a wearable device 305.

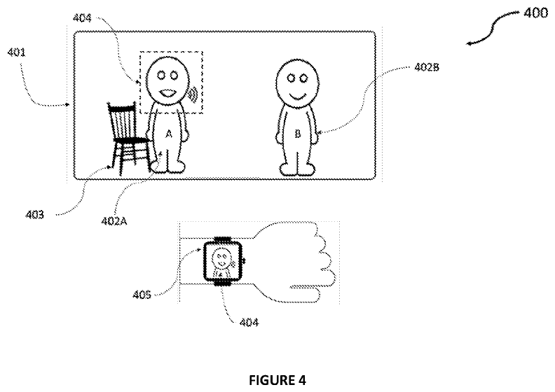

FIG. 4 shows a scenario 400 where one subject is performing an action while there are more than one subjects are present in frames of a video segment. In the exemplary scenario, a frame 401 have a first human subject 402A, a second human subject 402B, and an other object 403. The first human subject 402A in the frame is speaking while the second human subject is standing and not speaking, which makes face of the first human subject 402A as an object of interest in this scenario 400. The AI engine determines the object of interest based on either action recognition (i.e. lip movement), weightage of vocals (or direction of voice) in audio channel in corresponding video segment. Alternatively, AI engine can use voice recognition and face recognition to identify corresponding human subject in a video segment. Accordingly, a crop region 404 is determined around the face of the first human subject 402A and displayed on wearable device 405.

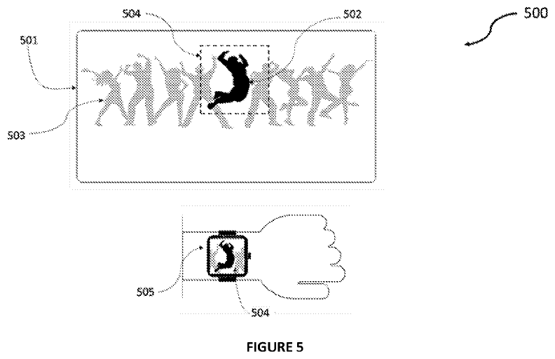

FIG. 5 shows a scenario 500 having a frame 501 of a dance video. The frame 501 contains a lead dancer 502 and a group of background dancers 503. The object of interest is the lead dancer 502, the AI engine fetches artist names from video title or hashtag or from other video information. The AI engine (pertained with artist names and corresponding face or images) determines the lead dancer 502 in the frame using face recognition. A crop region 504 is determined around the lead dancer 502 and the crop region 504 is displayed on a wearable device 505.

If a portion of video or any video segment contains frames with multiple objects or no objects due to which an object of interest cannot be determined such portion of video is played back uncropped or at a default crop setting (i.e. cropping a 16:9 aspect ratio video into 4:3 aspect ratio).

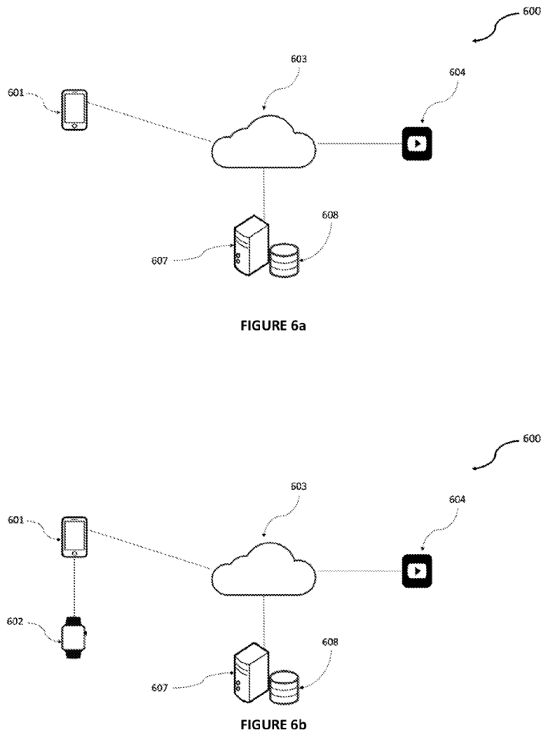

FIG. 6a illustrates a video cropping platform 600 for dynamic cropping of video. The video cropping platform 600 includes a smartphone 601 having a small display. The smartphone 601 is connected to a network (internet) 603. A server 607 enables crawling of one or more online video databases (604) and identifies one or more videos, which can be effectively cropped. The server 607 also process the identified one or more videos using the AI engine. The server determines object(s) of interest in the video segments for each of the identified one or more videos and corresponding dynamic crop regions. Alternatively, the server determines information which can be sent to the smartphone 601 for a selected video from the identified one or more videos, to enable dynamic cropping of the selected video by the smartphone. The one or more databases 608 stores the address (URLs) of the identified one or more videos. The one or more databases also store the information of dynamic crop regions for each identified one or more videos. The server can be a central server, a distributed server or a cloud service. The one or more databases can be a datacenter or a cloud storage.

FIG. 6b further illustrates the video cropping platform 600. A wearable device 602 is coupled (paired) with the smartphone 601 as a companion device having even smaller display than the smartphone 601. In this example, the wearable device 602 plays the selected video where the dynamic crop on selected video is applied by the smartphone 601, and cropped video is transmitted to the wearable device for playback.

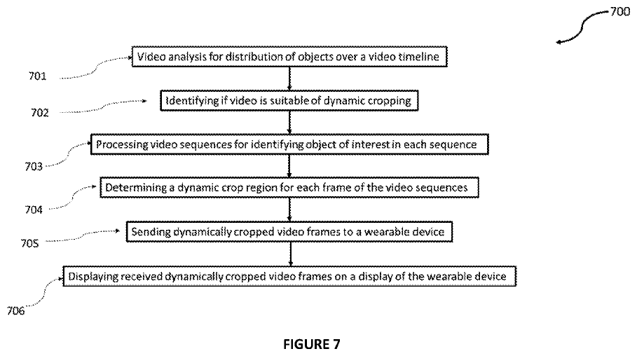

FIG. 7 illustrates a block diagram of a method 700 for dynamic cropping of video. At 701 video is analysed for distribution of objects contained in the video across a video timeline. At 702, it is identified whether the video is suitable for dynamic cropping based on the distribution of objects contained in the video across a video timeline. The suitability is identified based on the presence of one or more objects of interests are present across a majority of portion of the timeline of the video. If the video is identified as suitable for dynamic cropping, at 703 individual video segments (video sequences) are processed using the AI engine for identification of object(s) of interest in each of the video segments. At 704, a crop region is determined based on the position of identified object of interest for the frames of the video segments. At 705, the cropped region is sent to a small display device (i.e. wearable device). A stream of cropped frames are sent to the wearable device along with audio track of the video to be played back in sync by the wearable device. At 706, the wearable device displays the received cropped region.

Present invention is not restricted to videos but it can be applied to cropping images as well where context of image can be identified based on image metadata, image tag, hashtag, social media information, associated webpage information etc.

As used herein, the term engine refers to software, firmware, hardware, or other component that can be used to effectuate a purpose. The engine will typically include software instructions that are stored in non-volatile memory (also referred to as secondary memory). When the software instructions are executed, at least a subset of the software instructions can be loaded into memory (also referred to as primary memory) by a processor. The processor then executes the software instructions in memory. The processor may be a shared processor, a dedicated processor, or a combination of shared or dedicated processors. A typical program will include calls to hardware components (such as I/O devices), which typically requires the execution of drivers. The drivers may or may not be considered part of the engine, but the distinction is not critical.

As used herein, the term database is used broadly to include any known or convenient means for storing data, whether centralized or distributed, relational or otherwise.

As used herein a mobile device includes, but is not limited to, a cell phone, such as Apple's iPhone®, other portable electronic devices, such as Apple's iPod Touches®, Apple's iPads®, and mobile devices based on Google's Android® operating system, and any other portable electronic device that includes software, firmware, hardware, or a combination thereof that is capable of at least receiving the signal, decoding if needed, exchanging information with a transaction server to verify the buyer and/or seller's account information, conducting the transaction, and generating a receipt. Typical components of mobile device may include but are not limited to persistent memories like flash ROM, random access memory like SRAM, a camera, a battery, LCD driver, a display, a cellular antenna, a speaker, a Bluetooth® circuit, and WIFI circuitry, where the persistent memory may contain programs, applications, and/or an operating system for the mobile device.

A used herein, the term “wearable device” is anything that can be worn by an individual and that has a back side that in some embodiments contacts a user's skin and a face side. Examples of wearable device include but are not limited to a cap, arm band, wristband, garment, and the like.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

### Glossary of Terms

A video segment (or chunk) is a fragment of video information that is a collection of video frames. Combined together, these segments make up a whole video. Generally, the video segment includes consecutive frames that are homogeneous according to some defined criteria. In the most common types of video segmentation, video is partitioned into shots, camera-takes, or scenes.

### In a Compressed Video:

An I frame (Intra-coded picture) is a complete image, like a JPG or BMP image file.

A P frame (Predicted picture) holds only the changes in the image from the previous frame. For example, in a scene where a car moves across a stationary background, only the car's movements need to be encoded. The encoder does not need to store the unchanging background pixels in the P frame, thus saving space. P frames are also known as delta frames.

A B frame (Bidirectional predicted picture) saves even more space by using differences between the current frame and both the preceding and following frames to specify its content.

P and B frames are also called Inter frames.

1. A method for cropping a video segment, comprising:
determining context of the video segment;
based on determined context of the video segment, identifying at least one object of interest in the video segment;
determining boundary of the identified at least one object of interest in a first frame of the video segment;
determining a crop window surrounding to the determined boundary of the at least one object of interest in the video segment; and
cropping the first video frame based on the determined crop window.

2. The method of claim 1 wherein context of the video is determined based on supplementary video data, wherein supplementary video data includes at least one of the video title, video metadata, video hashtag, video description etc.

3. The method of claim 1 wherein context of the video is determined based on the direction of vocals associated with position of an object among two or more objects present in the videos segment.

4. The method of claim 1 wherein context of the video is determined based on an action associated with an object among two or more objects present in the videos segment.

5. The method of claim 1 wherein context of the video is determined based on one or more of a face detection, an emotion detection, a human body detection, an animal detection, a lip movement, face and body movement detection.

6. The method of claim 1 wherein the crop window is adapted in a second frame based on the change in position of at least one object of interest in the second frame, wherein the change in position of at least one object of interest is determined based on motion vectors associated with at least one object of interest.
